(19) United States
(12) Patent Application Publication
(10) Pub. No.: US 2020/0154093 A1
(43) Pub. Date: May 14, 2020

(54) SYSTEM FOR INSERTING ADVERTISING CONTENT AND OTHER MEDIA ON TO ONE OR MORE SURFACES IN A MOVING 360-DEGREE VIDEO

(71) Applicant: SPINVIEW GLOBAL LIMITED, London (GB)

(72) Inventor: Greg Roach, Tunjunga, CA (US)

(21) Appl. No.: 16/681,254

(22) Filed: Nov. 12, 2019

Related U.S. Application Data
(60) Provisional application No. 62/758,122, filed on Nov. 9, 2018.

(51) Int. Cl. H04N 13/183; H04N 13/156; G06Q 30/02

(52) U.S. Cl. CPC H04N 13/183; G06Q 30/0276; H04N 13/156

(57) ABSTRACT

A system for inserting advertising content and other media on one or more surfaces in a moving 360-degree video using computers has one or more processors, a client device connected to a network, and a memory coupled to the one or more processors. The processors enable a viewer to select a moving 360-degree video with at least one ad insertion surface, review a plurality of ad insertion surfaces each having a preset timecode and a preset geometry while simultaneously presenting a plurality of ads, insert an ad into one of the ad insertion surfaces in the selected moving 360-degree video, finalize the moving 360-degree video with the at least one ad, and flatten the moving 360 video into a composite moving video.360-degree

### CROSS-REFERENCE TO RELATED APPLICATIONS

The application claims the benefit of U.S. Provisional Application Ser. No. 62/758,122, filed on Nov. 9, 2018, the entire contents of which are hereby incorporated by reference.

### FIELD

The present embodiment generally relates to a system for inserting advertising content and other media on one or more surfaces in a moving 360-degree video.

### BACKGROUND

A need exists for an advertising system viewable on expanding and contracting moving videos using moving targets, particularly for virtual reality and immersive media.

The present embodiments meet these needs.

### BRIEF DESCRIPTION OF THE DRAWINGS

The detailed description will be better understood in conjunction with the accompanying drawings as follows:

FIG. 1 depicts equipment that can be used in the system.

FIGS. 2A, 2B, and 2C depict the memory of the system.

FIG. 3 is a diagram of a series of steps to implement the system.

The present embodiments are detailed below with reference to the listed figures.

### DETAILED DESCRIPTION OF THE EMBODIMENTS

Before explaining the present system in detail, it is to be understood that the system is not limited to the particular embodiments and that it can be practiced or carried out in various ways.

Embodiments of the disclosure described herein relates to a system for inserting advertising content on one or more surfaces in a moving 360-degree video. The system includes computer processors which perform a series of acts in order to insert advertising content on one or more surfaces in a moving 360-degree video. The series of acts performed by the computer processors include, enabling a viewer to select a moving 360-degree video with at least one ad insertion surface; reviewing a plurality of ad insertion surfaces, each having a preset timecode and a preset geometry, while simultaneously presenting a plurality of ads; inserting an ad into one of the ad insertion surfaces in the selected moving 360-degree video; finalizing the moving 360-degree video with the at least one ad; and then flattening it into a composite moving video.

Embodiments of the disclosure described herein benefits the environment by reducing the need to show customers advertising surfaces in person. This system will enable sponsors to see advertising surfaces as if they were in person at a location without needing to use transportation means that pollute the environment.

Another added benefit of the embodiments of the disclosure described herein is a reduced dependence on fossil fuels.

Additionally, another benefit of the embodiments of the disclosure described herein is that people with limited mobility, whether elderly or handicapped, can now participate and earn gainful employment in the ad business which otherwise precluded them due to their inability to travel.

The term “ad insertion surface” refers to a display surface on an object in the video, such as a car, taxi, billboard, or a jacket, which can present a logo or ad content to a viewer experiencing the video.

The term “composite moving video” refers to the pre-flattened combination of an ad into ad insertion surfaces.

The term “custom created ad” refers to an ad, which is fully complete but not contained in the Library of Ads.

The term “flattening” refers to the final version of a multiplexed video with or without audio.

The term “Library of Ads” refers to a database of prewritten ads which can be searchable by author, date and time, content, sponsor, specific logo, keywords, and characters in the ad. In embodiments, the Library of Ads can be visually browsed for background content or other attributes. The Library of Ads can be searched by area, ad format (horizontal or vertical), duration of the ad, whether or not the ad has companion pieces, and history of the ad.

The term “moving 360-degree video” refers to a recording formed (i) with a static camera and a static environment, (ii) with a moving camera and a static environment; (iii) with a moving camera, a static environment and a moving object passing through the static environment; (iv) with a static camera and a static environment with a moving object passing through the static environment.

The term “plurality of ads” refers to presenting two or more images, two or more pictures, an image with words, or a combination of word messages on a single screen while looking at ad insertion surfaces using the same single screen. In embodiments, the images could be still images or moving images, such as video ads. In embodiments, the moving images could be animated images.

The term “preset timecode” refers to a start and stop timecode during which one of the ad insertion surfaces, if visible to a viewer experiencing the video, is expected to be in minutes and seconds, but can also be indicated in frames, fields, subframes, or any other appropriate unit of measure.

The term “preset geometry” refers to geometric shapes having an area which changes over time given the perspective of a viewer, and wherein the changing area accepts and presents all of the ad content as the area changes in shape. For example, a rendered image should change in size as the object in the video moves. As another example, the font size might start at 9 points and grow to 12 points and then decrease to 6 points as the viewer moves towards and past a billboard. As another example, a logo may start small, as a car drives toward the viewer, get larger, and then disappear completely as the car makes an abrupt turn into a garage. Part of the term “preset geometry” refers to the geometric shape, such as a rectangular billboard. Other shapes, such as triangles, can be used if the moving object is a sailboat and the surface is a jib or main sheet of the sailboat. A patch on a uniform could be a polygon or a circle, and the ad insertion surface would be the geometric shape of that patch.

The term “prerecorded moving 360-degree video from a Library of 360-degree videos” refers to recorded moving 360-degree videos created by an administrator of the system and contained in a Library of 360-degree videos in the memory associated with an administrative processor. For example, a prerecorded moving 360-degree video in the Library can be a video of an interior of an airport.

The term “uploaded moving 360-degreedegree video” refers to a moving 360-degree video created by a user or third party source which is not in the Library of 360-degree videos associated with an administrative processor.

Embodiments of the disclosure described herein relates to a system for inserting advertising content on one or more surfaces in a moving 360-degree video.

Embodiments of the disclosure described herein are primarily used to insert advertising content on to one or more surfaces to those who need it, but the limitation is not inherent in the embodiments of the disclosure itself. Any kind of media can be inserted on to the one or more surfaces for instance, informational media or signage.

Normally, in order to replace a display surface inside of a 360-degree video, a special effects post-processing workflow with a trained operator is required. Embodiments of the disclosure described herein allow a non-technical person to select the display surface, apply media to it, and then render out the usable result for 360-degree video without them having to have any technical skill or having to use a low level special effects tool.

There are two main parts to the overall system. The first part is altering and preparing the media to be inserted on one or more surfaces, and the second part is adding that media into the system described herein for use by a non-technical person.

The first main part involves capturing a real world location, processing that media, and setting up that project so that it is ready to be used inside of the online tool. A user who wishes to employ the system disclosed herein physically goes out to a real world location and films a 360-degree view of that real world location. For example, an airport. A 360-degree camera can be attached to a vehicle and as the vehicle approaches the airport, the camera films that footage. That footage is then processed by stitching the individual movements together. This is standard media processing for 360-degree media. Then, those individual display surfaces from the video are defined and tracked, and that information is then entered into the online system described herein.

Display surfaces are inside the 360-degree video. So, for example, if the video is a minute of road travel dimensions to an airport, the display surfaces defined in the video are going to be the billboards present in the video. A display surfaces can be surface inside of a moving 360-degree video that can be overwritten or replaced with some other media. A display surface is not limited to a billboard. A display surface can also be a traffic sign, the side of a building, a television display, or anything the user selects to be a display surface.

The display surface can also move within the 360-degree video. For instance, a display surface can also be the side of a bus or taxi.

The display surfaces in the embodiments of the system disclosed herein are defined and their placement in space is tracked through that 360-degree video.

The display surface information, the media of the 360-degree video, and any other data is then entered into the system.

This is all a part of the preparation phase. The next phase is employed when there is an end user who wants to be able to replace the content in those display surfaces defined in the 360-degree video. The end user selects the media clip that they want to use. In this case, the video of driving into the entrance to the airport can be selected. The end user can choose which of those predefined display surfaces they want to replace. So, for example, there may be three billboards in the original 360-degree video and this user just wants to replace the two of them. The user would select those two display surfaces and then select the media (advertisement, information, or perhaps just a different color scheme) that they want to replace into that display surface.

The user can upload the desired replacement media from a local computer or from inside of the library tool in the platform. The user then designates the replacement media, applies this replacement media to the display surface, and creates an output video with both the original 360-degree video and the selected desired media combined.

The output video is the finished product which is the actual advertisement or selected desired media on that display surface.

A video that includes the combination of the original source video, the data for the display surfaces, the tracking for those display surfaces, and the replacement media the user defined is created. These all are used together to generate the final output video.

One of the practical uses of the system disclosed herein is apparent in this brief example. An advertising salesperson is attempting to sell three billboards driving into George Bush International Airport to prospective clients. The advertising salesperson has created a 360-degree video with Pepsi the ads to replace the Coca Cola ads that were originally on those three billboards. The resulting 360-degree video can be shared with the client so they can see what that media purchase would look like without having to perform an on-site visit. The client can instead use the immersive 360-degree video to go to that site and visualize what their purchased ad space would look like.

In another example, the client is in the transportation industry, subways to be specific. The client wants to try out a new information system design from the experience of a person who is actually walking through the space. The space can be recorded using a 360-degree video and the surface can be tracked for the old information display. Then, that old information can be replaced with the new information display design, rendered into a final output 360-degree video, and given to the client for that first person experience.

The generated output videos can be consumed in numerous ways including through virtual reality headsets, computers, mobile phones, iPads, or any other way that visualization with immersive media can be consumed.

Normally, the process of recording the 360-degree video, defining the display surfaces, tracking them, and then replacing the content in the rendering and output is a very technical process. It is a specialized process that requires specialized skills and tools. The system disclosed herein replaces the need for specialized skills and specialized tools and allows a non-technical user to be able to replace a display with a desired piece of media and receive a 360-degree output video.

The system includes one or more processors communicating with a network, such as a cellular network or the Internet.

The system includes a client device such as a laptop or cell phone, communicating with the network.

Memory is coupled to the one or more processors and stores computer-executable instructions that, when executed by the one or more processors, the one or more processors perform a variety of acts including selecting a moving 360-degree video with at least one ad insertion surface.

The moving 360-degree video is selected from an uploaded moving 360-degree video provided by a third party, a viewer, or 360-degreea Library of 360-degree videos in the memory containing a plurality of prerecorded moving 360-degree videos.

The processors use instructions in the memory to enable review of a plurality of ad insertion surfaces in a selected moving 360-degree video with each ad insertion surface having a preset timecode and a preset geometry.

The preset time code is a start and stop interval. The preset geometry is a shape and an area that can deform, expand, or contract.

The processors, using instructions in the memory, enable the Library of ads, which is stored in the memory, to present a plurality of ads.

In embodiments, the processors can use instructions to select a custom created ad for insertion in one of the plurality of ad insertion surfaces.

The processors using instructions in the memory can insert at least one of the plurality of ads or a custom created ad into one of the ad insertion surfaces in the selected moving 360-degree video.

The processors using instructions in the memory can finalize the moving 360-degree video with the at least one ad into a composite moving video.

The processors using instructions in the memory can flatten the composite moving video.

In embodiments, the system for inserting advertising content on one or more surfaces in a moving 360-degree video can involve inserting multiple different ads on multiple ad insertion surfaces simultaneously.

In embodiments, the system for inserting advertising content on one or more surfaces in a moving 360-degree video can have computer instructions instructing the processor to automatically generate a preview of a composite moving video with a first ad on the first surface, configured to enable a viewer to replace the first ad with a second ad prior to finalizing the composite moving video.

In embodiments, the system for inserting advertising content on one or more surfaces in a moving 360-degree video can include a “Machine Vision System with GPU Architecture” configured to identify one or more ad insertion surfaces by time code and preset geometry, and automatically insert at least one ad into one of the ad insertion surfaces based on the time codes and preset geometry.

In embodiments, the system for inserting advertising content on one or more surfaces in a moving 360-degree video can use custom inserting ranges of time codes and custom inserting geometries for each ad insertion surface.

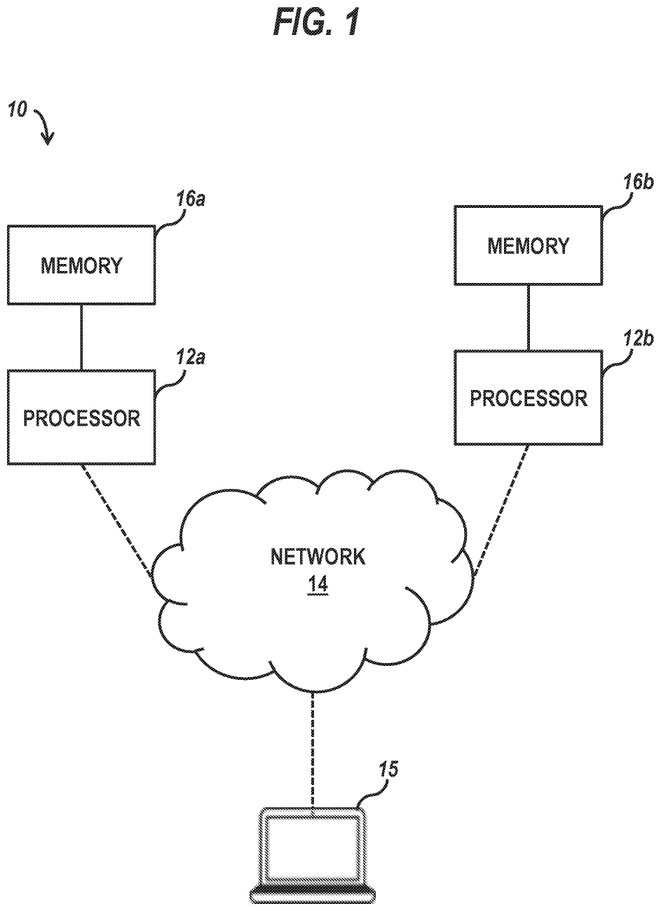

Turning now to the Figures. FIG. 1 shows equipment usable for the system 10 for inserting advertising content on one or more surfaces in a moving 360-degree video.

The equipment includes one or more processors 12a and 12b communicating with a network 14, which can be a global communication network.

A client device 15 communicates with the network 14.

Memory 16ab is coupled to the one or more processors and stores computer-executable instructions that, when executed by the one or more processors, perform a variety of tasks.

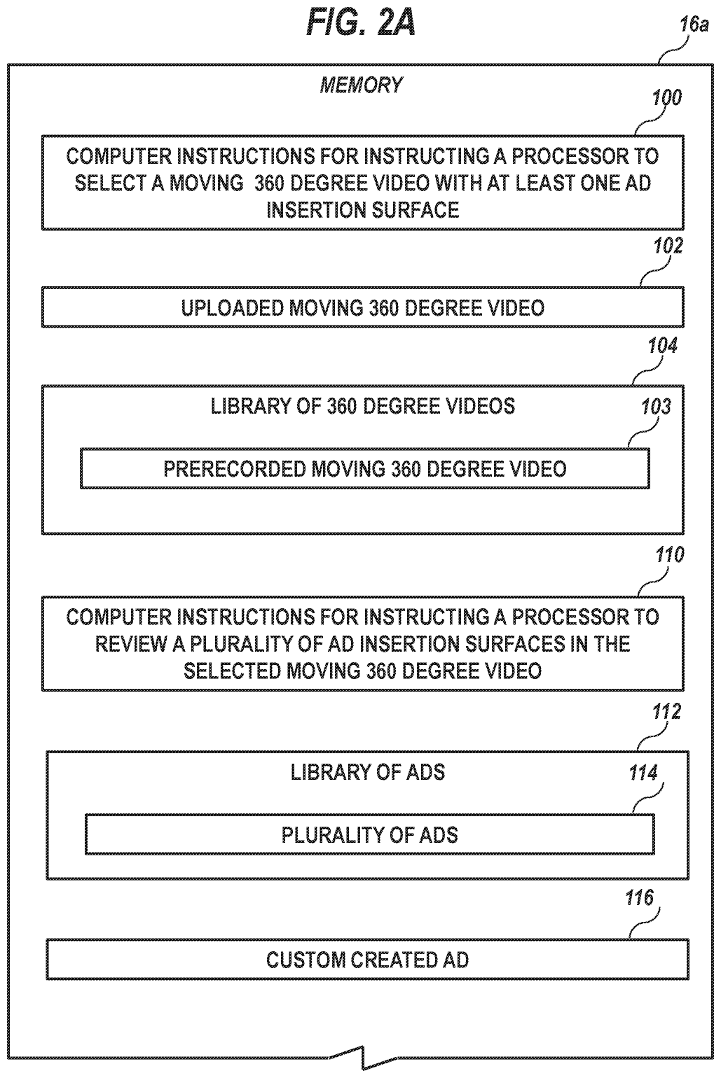

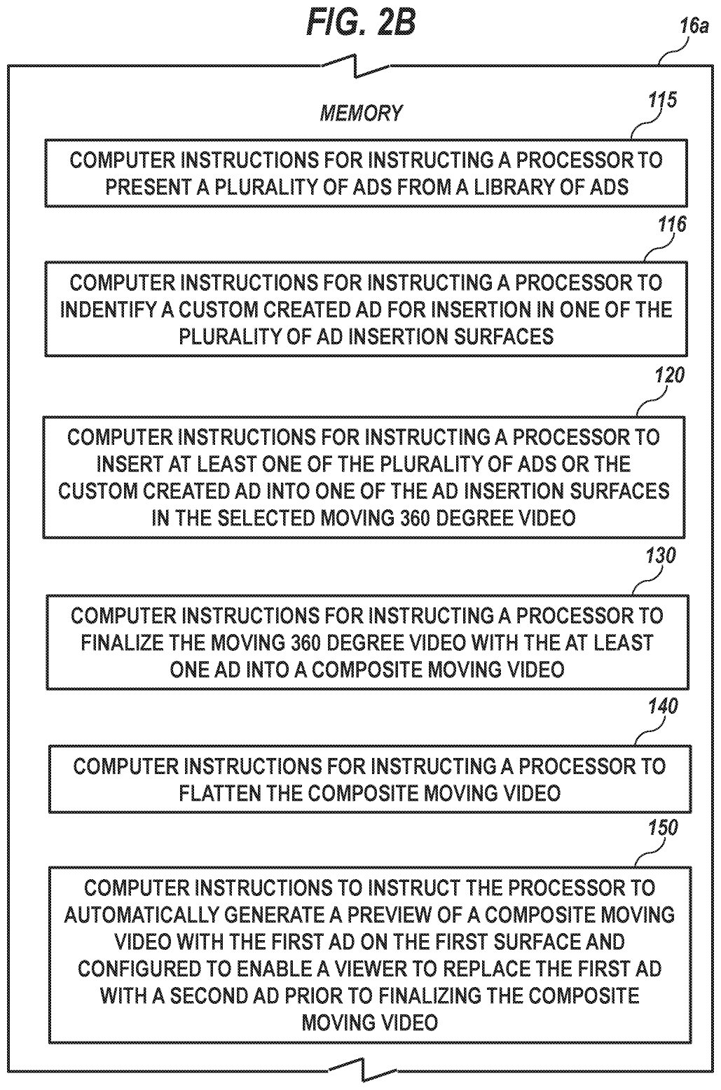

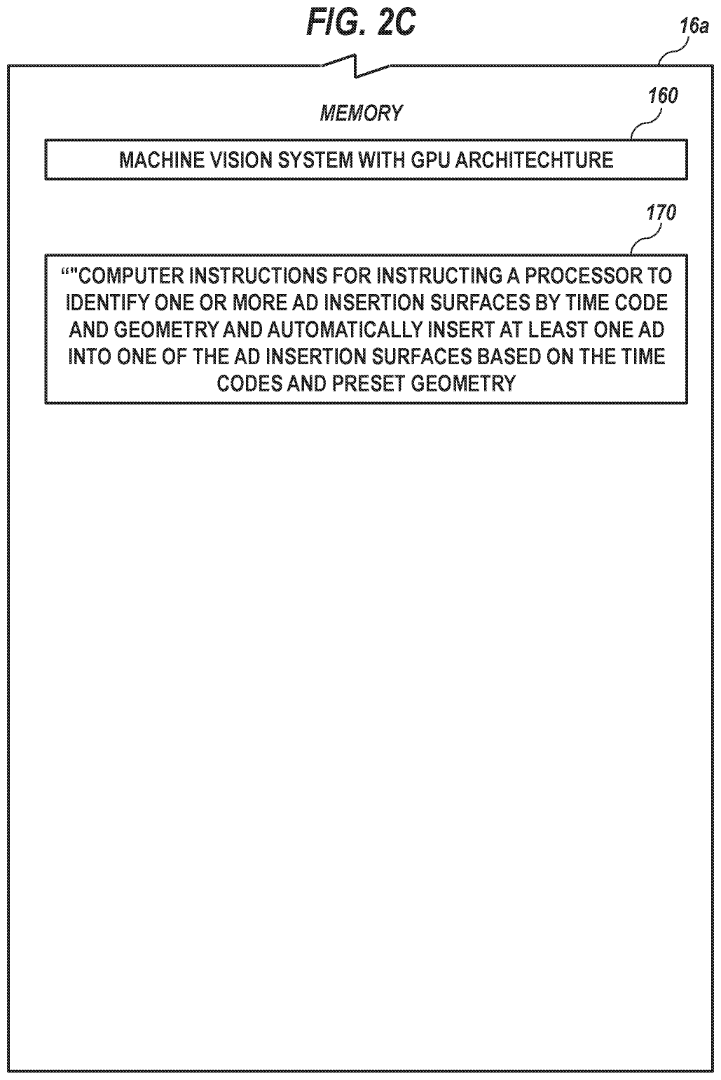

FIGS. 2A, 2B, and 2C describe the memory 16a usable by the equipment.

Memory 16a includes computer instructions that instruct the one or more processors to select a moving 360-degree video with at least one ad insertion surface 100.

Memory 16a includes an uploaded moving 360-degree video 102.

Memory 16a includes a Library of 360-degree videos 104 and a prerecorded moving 360-degree video 103 in that Library of 360-degree videos.

Memory 16a includes computer instructions that instruct the one or more processors to review a plurality of ad insertion surfaces in the selected moving 360-degree video 110, wherein each ad insertion surface has a preset timecode and a preset geometry.

Memory 16a includes a Library of Ads 112 containing a plurality of ads 114.

Memory 16a also includes a custom created ad 116.

Memory 16a includes computer instructions that instruct the one or more processors to present a plurality of ads 114 from a Library of Ads 112 in memory connected to one of the processors on a client device 115.

Memory 16a includes computer instructions that instruct the one or more processors to identify a custom created ad for insertion in one of the plurality of ad insertion surfaces 116.

Memory 16a includes computer instructions that instruct the one or more processors to insert at least one of the plurality of ads or the custom created ad 116 into one of the ad insertion surfaces in the selected moving 360-degree video 120.

Memory 16a includes computer instructions that instruct the one or more processors to finalize the moving 360-degree video with the at least one ad into a composite moving video 130.

Memory 16a includes computer instructions that instruct the one or more processors to flatten the composite moving video 140.

Memory 16a includes computer instructions 150 instructing the processor to automatically generate a preview of a composite moving video with the first ad on the first surface and is configured to enable a viewer to replace the first ad with a second ad prior to finalizing the composite moving video.

Memory 16a includes a “Machine Vision System with GPU Architecture” 160 configured to identify one or more ad insertion surfaces by time code and geometry, and automatically insert at least one ad into one of the ad insertion surfaces based on the time codes and preset geometry.

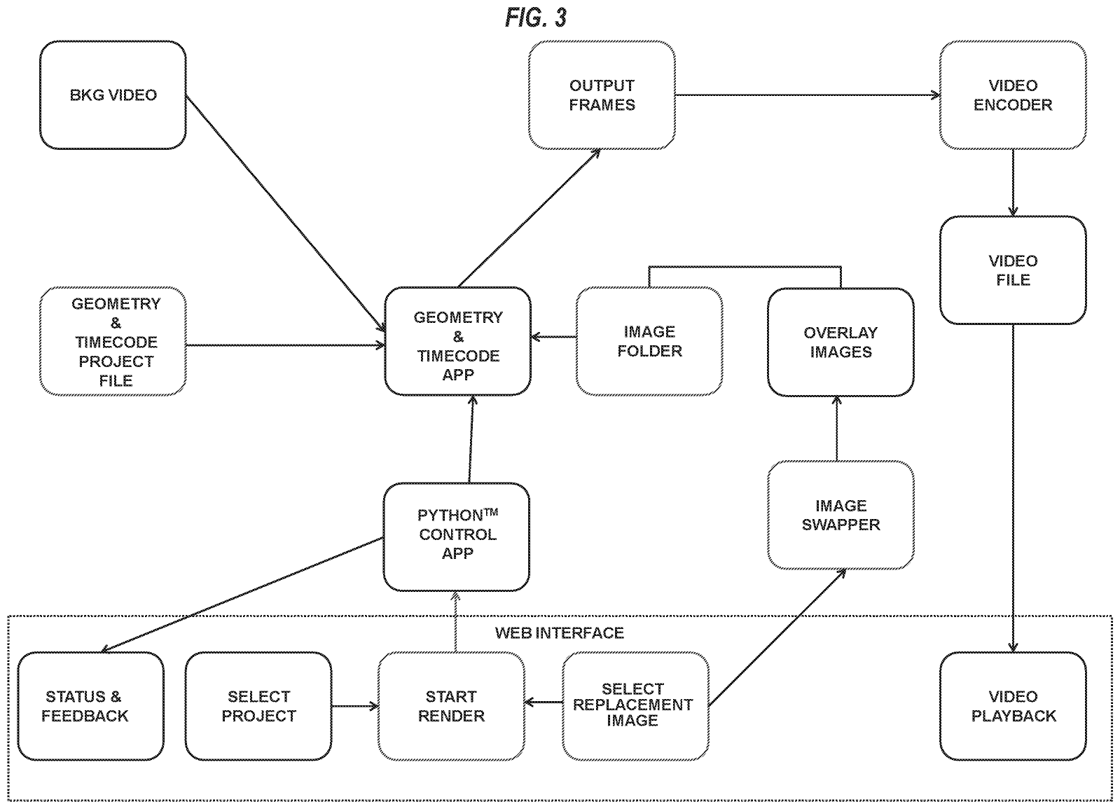

FIG. 3 depicts a background video, identified in the figure as “BKG VIDEO”, that is then assigned a geometry and a timecode using a “Geometry and Timecode App” in the memory of an administrative processor, which receives information from a geometry and timecode project file and an image folder.

The “Geometry and Timecode App” provides output frames with geometries and time codes that are then transferred to a video encoder that creates a video file for video playback.

Using a web interface, replacement images can be selected and transferred to an application that starts rendering the images, which then transfers the rendered images to a Python™. A Python™ is a control application that provides status and feedback to the “Geometry and Timecode App” and to a client device.

In other embodiments, the project selected can automatically start a rendering, which informs the “Geometry and Timecode App” to initiate coding.

The select replacement image step of the web interface can transfer images to an image swapper, overlay images, and store the overlaid images in an image folder for additional timecode and geometry stamps.

### Example 1

In the system for inserting advertising content on one or more surfaces in a moving 360-degree video, two cloud based processors can be used. In other examples, any number of processors connected together can be used.

In this example the two cloud based processors are each connected to a memory.

Each memory can be a 64 gigabyte memory. The memory can also be cloud based.

The processors are connected to the Internet, which enables the system to be a device that can be used with a global communication network.

The processors and the memory can be expanded or shrunken depending on the user's need.

In the memory are computer-executable instructions that, when executed by the two cloud based processors, perform various acts.

These acts include transmitting a display screen to a client device of a user which enables the user to select a moving 360-degree video with at least one ad insertion surface from a plurality of prerecorded moving 360-degree videos in a Library of 360-degree videos also stored in the memory of one of the processors.

In this example, the user picks a Formula 1 car race video.

Next, the cloud based processor transmits a display screen to the same client device enabling the user to review all ad insertion surfaces in the selected moving 360-degree video, which are rectangular and can support a logo that is as small as about 100 pixels to about 500 pixels in each rectangular space.

The viewer is simultaneously presented with a timecode (start and stop) and a geometric shape (square, triangle, or circle, with an area defined in pixels, inches or centimeters) while seeing a display ad for insertion on each ad insertion surface.

The viewer then selects all the rectangular billboards in the moving 360-degree video.

The plurality of ads can be grouped by category or by priority based on sponsor defined criteria and can be viewed from a drop down menu in a Library of Ads located in the memory connected to at least one of the processors.

The viewer selects ads for helmets, and then selects the manufacturer Harley Davidson, and finally selects a particular video ad that features a happy couple safely motoring on their motorcycles. Each selected ad is for a 15 second time code, a native rectangular geometry with a 2:1 aspect ratio that is high resolution, and scalable while still clearly viewable at about 500 pixels.

The processor then inserts the selected helmet ad into each rectangular billboard in the selected moving 360-degree video of Formula 1 racing.

The processor then finalizes the moving 360-degree video forming a composite moving video. Lastly, the composite moving video is flattened.

### Example 2

In the system for inserting advertising content on one or more surfaces in a moving 360-degree video, one processor can be used. The processor is in communication with a network, such as a global communication network like the Internet.

In this example the processor connects to a memory.

The memory can be a 16 gigabyte memory.

In the memory are computer-executable instructions that, when executed by the processor, transmit a display screen to a client device, such as a user's cell phone, which enables the user to upload a moving 360-degree video from his or her cell phone.

In this example, the user picks a video depicting Piccadilly Circus in London, England.

The time code and geometry for each ad insertion surface of the uploaded moving 360-degree video has to be measured.

After measurement is complete, the processor transmits a display screen to the cell phone, enabling the user to review all ad insertion surfaces in the uploaded moving 360-degree video, which can support a photograph that is as small as about 50 pixels to about 1000 pixels.

The user is simultaneously presented with all the timecodes (start and stop) and a selection of geometries corresponding to each time code while viewing ads for insertion on each ad insertion surface.

The user then selects all the ad insertion surfaces on moving buses in the moving 360-degree video.

The user then inserts a custom created ad from the memory of the user's cell phone for insertion in each of the ad insertion surfaces. The ad for this example is a “Fish and Chips” ad for a restaurant chain.

The custom created ad has a still image with a native rectangular geometry with a 3:1 aspect ratio that is high resolution, and scalable while still clearly viewable at about 1000 pixels.

The processor then inserts the custom created ad onto each bus display in the selected moving 360-degree video of Piccadilly Circus.

The processor finalizes the moving 360-degree video forming a composite moving video and then flattens the composite moving video.

In this example, the flattened composite moving video can be streamed to a viewer's cell phone for further use in marketing and advertising.

While these embodiments have been described with emphasis on the embodiments, it should be understood that within the scope of the appended claims, the embodiments might be practiced other than as specifically described herein.

What is claimed is:

1. A system for inserting advertising content on one or more surfaces in a moving 360-degree video comprising:
one or more processors communicating with a network;
a client device communicating with the network;
a memory coupled to the one or more processors which stores computer-executable instructions that, when executed by the one or more processors, the one or more processors perform acts comprising:
(i) selecting a moving 360-degree video with at least one ad insertion surface 360-degree from an uploaded moving 360-degree video;
(ii) 360-degree360-degreereviewing a plurality of ad insertion surfaces in the selected moving 360-degree video, each ad insertion surface having a preset timecode and a preset geometry;
(iii) presenting a plurality of ads from a Library of Ads in the memory connected to one of the processors; or identifying a custom created ad for insertion onto one of the plurality of ad insertion surfaces in the selected moving 360-degree video;
(iv) inserting at least one of the plurality of ads or the custom created ad onto one of the ad insertion surfaces in the selected moving 360-degree video;
(v) finalizing the moving 360-degree video with the at least one ad into a composite moving video; and
(vi) flattening the composite moving video.

2. The system for inserting advertising content on one or more surfaces in a moving 360-degree video of claim 1, further comprising inserting multiple different ads on multiple ad insertion surfaces simultaneously.

3. The system for inserting advertising content on one or more surfaces in a moving 360-degree video of claim 1, further comprising computer instructions instructing the at least one processor to automatically generate a preview of a composite moving video with a first ad on a first surface, and is configured to enable a viewer to replace the first ad with a second ad prior to finalizing the composite moving video.

4. The system for inserting advertising content on one or more surfaces in a moving 360-degree video of claim 1, further comprising a “Machine Vision System with GPU Architecture” configured to identify one or more ad insertion surfaces by geometry and time code, and automatically insert at least one ad into one of the ad insertion surfaces based on the geometry and time codes.

5. The system for inserting advertising content on one or more surfaces in a moving 360-degree video of claim 1, further comprising inserting custom ranges of geometries and time codes for each ad insertion surface.

6. The system for inserting advertising content on one or more surfaces in a moving 360-degree video of claim 4, wherein the geometry and timecode uses a “Geometry and Timecode App” which provides output frames with geometries and time codes that are then transferred to a video encoder that creates a video file for video playback.

7. The system for inserting advertising content on one or more surfaces in a moving 360-degree video of claim 1, wherein a web interface is used to select and transfer replacement images to an application that starts rendering the images, which then transfers the rendered images to a Python™.

8. The system for inserting advertising content on one or more surfaces in a moving 360-degree video of claim 7, wherein the replacement images selected can automatically start a rendering, which informs the “Geometry and Timecode App” to initiate coding.

9. The system for inserting advertising content on one or more surfaces in a moving 360-degree video of claim 7, wherein the web interface can transfer images to an image swapper, overlay images, and store the overlaid images in an image folder for additional timecode and geometry stamps.

10. A system for inserting advertising content on one or more surfaces in a moving 360-degree video comprising:
one or more processors communicating with a network;
a client device communicating with the network;
a memory coupled to the one or more processors which stores computer-executable instructions that, when executed by the one or more processors, the one or more processors perform acts comprising:
(i) selecting a moving 360-degree video with at least one ad insertion surface from a prerecorded moving 360-degree video from a Library of 360-degree videos in the memory connected to one of the processors;
(ii) reviewing a plurality of ad insertion surfaces in the selected moving 360-degree video, each ad insertion surface having a preset timecode and a preset geometry;
(iii) presenting a plurality of ads from a Library of Ads in the memory connected to one of the processors; or identifying a custom created ad for insertion onto one of the plurality of ad insertion surfaces in the selected moving 360-degree video;
(iv) inserting at least one of the plurality of ads or the custom created ad onto one of the ad insertion surfaces in the selected moving 360-degree video;
(v) finalizing the moving 360-degree video with the at least one ad into a composite moving video; and
(vi) flattening the composite moving video.

11. The system for inserting advertising content on one or more surfaces in a moving 360-degree video of claim 10, further comprising inserting multiple different ads on multiple ad insertion surfaces simultaneously.

12. The system for inserting advertising content on one or more surfaces in a moving 360-degree video of claim 10, further comprising computer instructions instructing the at least one processor to automatically generate a preview of a composite moving video with a first ad on a first surface and is configured to enable a viewer to replace the first ad with a second ad prior to finalizing the composite moving video.

13. The system for inserting advertising content on one or more surfaces in a moving 360-degree video of claim 10, further comprising a “Machine Vision System with GPU Architecture” configured to identify one or more ad insertion surfaces by geometry and time code, and automatically insert at least one ad into one of the ad insertion surfaces based on the geometry and time codes.

14. The system for inserting advertising content on one or more surfaces in a moving 360-degree video of claim 10, further comprising inserting custom ranges of geometry and time codes for each ad insertion surface.

15. The system for inserting advertising content on one or more surfaces in a moving 360-degree video of claim 13, wherein the geometry and timecode uses a “Geometry and Timecode App” which provides output frames with geometries and time codes that are then transferred to a video encoder that creates a video file for video playback.

16. The system for inserting advertising content on one or more surfaces in a moving 360-degree video of claim 10, wherein a web interface is used to select and transfer replacement images to an application that starts rendering the images, which then transfers the rendered images to a Python™.

17. The system for inserting advertising content on one or more surfaces in a moving 360-degree video of claim 16, wherein the replacement images selected can automatically start a rendering, which informs the “Geometry and Timecode App” to initiate coding.

18. The system for inserting advertising content on one or more surfaces in a moving 360-degree video of claim 16, wherein the web interface can transfer images to an image swapper, overlay images, and store the overlaid images in an image folder for additional timecode and geometry stamps.
